(19) United States
(12) Patent Application Publication
(10) Pub. No.: US 2014/0355815 A1
(43) Pub. Date: Dec. 4, 2014

(54) Innovative Magnetic Design for Speakers

(71) Applicant: Lai-Shi HUNG, New Taipei City (TW)

(72) Inventor: Lai-Shi HUNG, New Taipei City (TW)

(21) Appl. No.: 13/906,770

(22) Filed: May 31, 2013

(51) Int. Cl. H04R 9/02

(52) U.S. Cl. CPC H04R 9/025
USPC 381/412

(57) ABSTRACT

An innovative magnetic design for speakers is disclosed. The innovative magnetic design of the present invention comprises an upper magnetic portion, a lower magnetic portion, at least one magnetic piece and two or more magnets. Either the upper magnetic portion or the lower magnetic portion has the form of a plate. A magnet is disposed between the upper magnetic portion and the magnetic piece, and another magnet is disposed between the lower magnetic portion and the magnetic piece. When an AC current flows through the voice coil, a magnetic force induced by the current would move the voice coil and diaphragm longitudinally, thereby generating audible sounds. In addition, we only have to increase the length of magnets 4 to increase their volume so as to increase the magnetic force and hence offset the decrease in the magnetic force due to a thinner configuration.

### BACKGROUND OF THE INVENTION

1. Field of the invention

The invention generally relates to a magnetic design for speakers. More particularly, the invention relates to an innovative magnetic design through which we can increase the length of magnets to increase their volume so as to increase the magnetic force and hence offset the decrease in the magnetic force due to a thinner configuration.

2. Description of the prior art

In the prior art speakers, magnet and a voice coil are encased and affixed in a box. As an AC current flows through the voice coil, a magnetic force induced by the current would move the voice coil and a diaphragm longitudinally, thereby generating audible sounds. However, such structure is no longer sufficient because all electronic products are made thinner and more compact, which can reduce the induced magnetic force and hence adversely affect the performance of speakers.

### SUMMARY OF THE INVENTION

The object of the present invention is to provide an innovative magnetic design through which we can increase the length of magnets to increase their volume so as to increase the magnetic force and hence offset the decrease in the magnetic force due to a thinner configuration.

To reach the object, the innovative magnetic design of the present invention is disclosed. The innovative magnetic design of the present invention comprises an upper magnetic portion, a lower magnetic portion, at least one magnetic piece and two or more magnets. Either the upper magnetic portion or the lower magnetic portion has the form of a plate. A magnet is disposed between the upper magnetic portion and the magnetic piece, and another magnet is disposed between the lower magnetic portion and the magnetic piece. The lower surface of the upper magnet, the upper surface of the lower magnet and the magnetic piece should be of the same polarity, and the upper surface of the upper magnet, the lower surface of the lower magnet, the upper magnetic portion and the lower magnetic portion should be of the opposite polarity.

### BRIEF DESCRIPTION OF THE DRAWINGS

FIG. 1 is a perspective view showing the innovative magnetic design for speakers of the present invention.

FIG. 2 is a side view illustrating the first embodiment of the present invention.

FIG. 3 is a side view illustrating the longitudinal movement of the voice coil and the diaphragm in the second embodiment of the present invention.

FIG. 4 is another side view illustrating the longitudinal movement of the voice coil and the diaphragm in the second embodiment of the present invention.

FIG. 5 is a perspective view illustrating the third embodiment of the present invention.

FIG. 6 is a perspective view illustrating the fourth embodiment of the present invention.

### LIST OF REFERENCE NUMERALS

| | |
|---|---|
| 1 Upper magnetic portion | 2 Lower magnetic portion |
| 3 Magnetic piece | 4 Magnets |
| 41 Ferrofluid | 5 Box |
| 6 Circular voice coil | 7 Affixing element |
| 8 Truncated cone-shaped basket | 81 Diaphragm |
| 82 Diaphragm | 83 Affixing point |
| 9 Folded structure | 10 Extended magnetic part(s) |

### DETAILED DESCRIPTION OF THE PREFERRED EMBODIMENTS

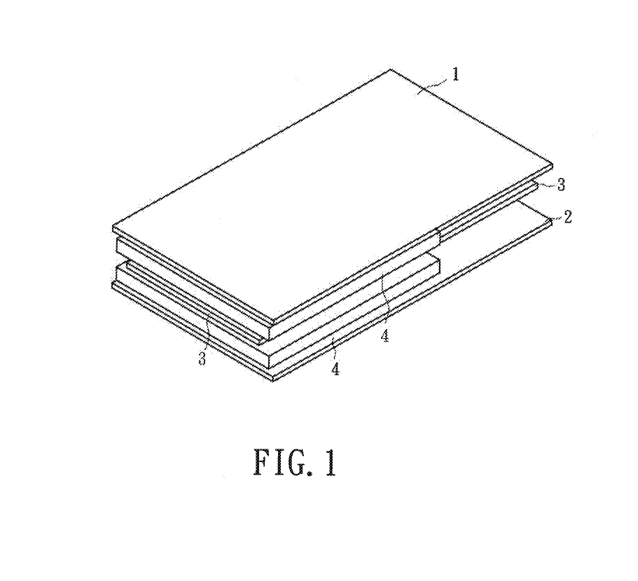

Please refer to FIG. 1. The innovative magnetic design for speakers of the present invention comprises an upper magnetic portion 1, a lower magnetic portion 2, at least one magnetic piece 3 and two or more magnets 4. Either the upper magnetic portion 1 or the lower magnetic portion 2 has the form of a plate. The magnetic piece 3 has a certain thickness and is disposed between the upper magnetic portion 1 and the lower magnetic portion 2. A magnet 4 is disposed between the upper magnetic portion 1 and the magnetic piece 3 and another magnet 4 is disposed between the lower magnetic portion 2 and the magnetic piece 3. In addition, either the lower surface of an upper magnet 4 or the upper surface of a lower magnet 4 should have the same magnetic polarity as the magnetic piece 3; the upper surface of the upper magnet 4 should have the same magnetic polarity as the upper magnetic portion 1 and the lower surface of the lower magnet 4 should have the same magnetic polarity as the lower magnetic portion 2. For example, if the lower surface of the upper magnet 4, the upper surface of the lower magnet 4 and the magnetic piece 3 are of south pole, then the upper surface of the upper magnet 4, the lower surface of the lower magnet 4, the upper magnetic portion 1 and the lower magnetic portion 2 should be of north pole. Conversely, if the lower surface of the upper magnet 4, the upper surface of the lower magnet 4 and the magnetic piece 3 are of north pole, then the upper surface of the upper magnet 4, the lower surface of the lower magnet 4, the upper magnetic portion 1 and the lower magnetic portion 2 should be of south pole.

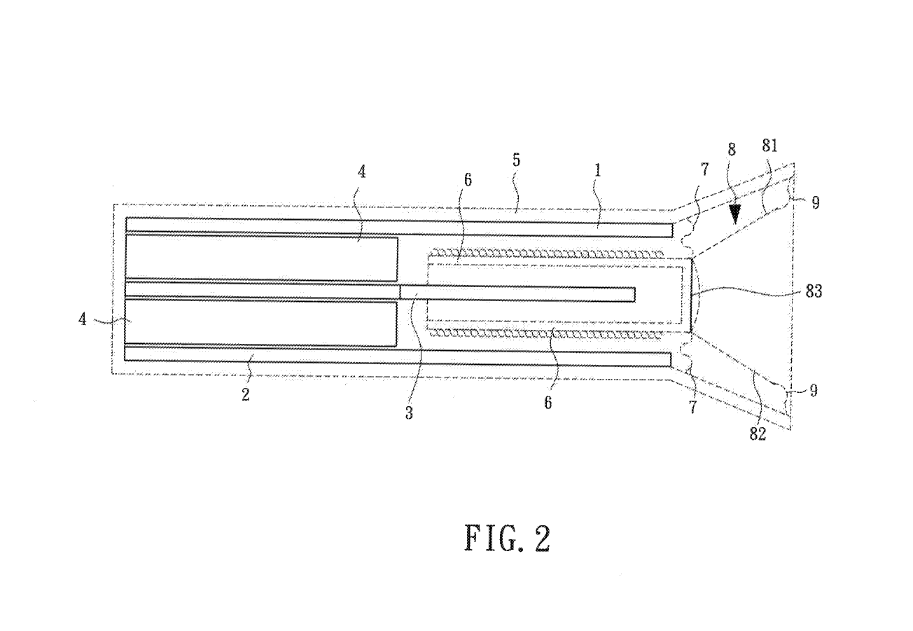

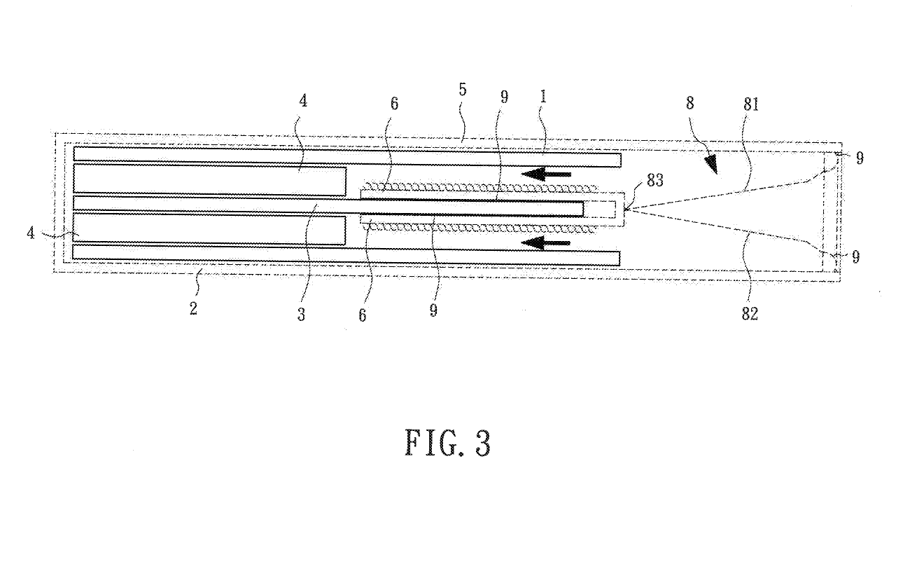

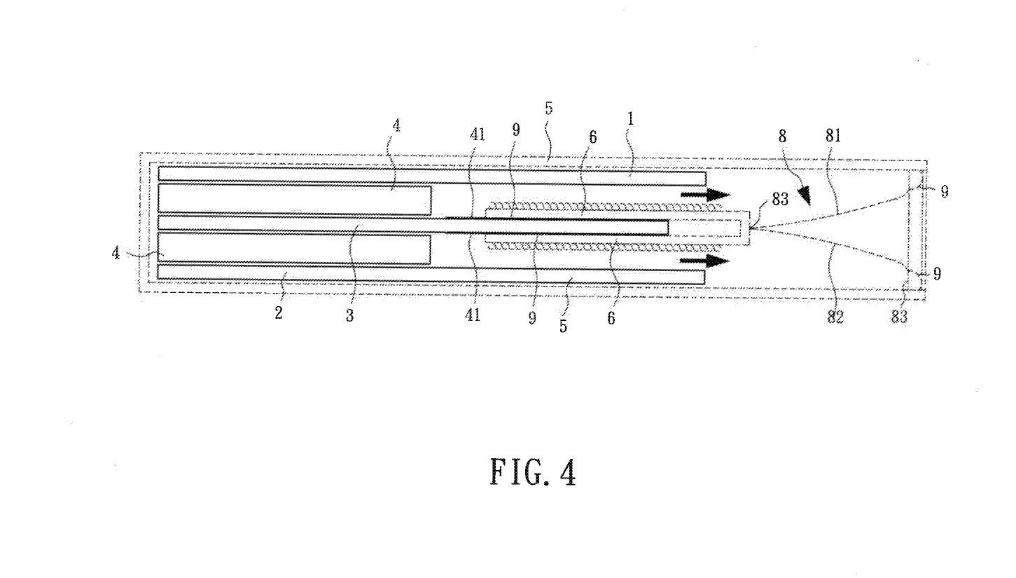

Please see FIGS. 2, 3 and 4, which illustrate the aforesaid components encased in a box 5. In the previously described polarity arrangement, a repulsive force exists between the upper magnetic portion 1, the upper magnet 4, the magnetic piece 3, the lower magnet 4 and the lower magnetic portion 2. In the present invention, glue, non-magnetized rivets or non-magnetic frames may be used to affix the upper magnetic portion 1, the upper magnet 4, the magnetic piece 3, the lower magnet 4 and the lower magnetic portion 2. An affixing element 7 is used to affix a circular voice coil 6 between the upper magnetic portion 1 and the lower magnetic portion 2 inside the box 5. The voice coil 6 wraps around one side of the magnetic piece 3. A truncated cone-shaped basket 8 is affixed on the voice coil 6 through glue or soldering and thus to form an affixing point 83. Diaphragm 81 and 82 is connected with the interior surface of the box 5 through a folded structure 9. When an AC current flows through the voice coil 6, a magnetic force induced by the current would move the voice coil 6 and diaphragm 81 and 82 longitudinally, thereby generating audible sounds. As illustrated in FIGS. 3 and 4, a ferrofluid 41 may be applied around the magnet 4 to allow the voice coil 6 to move or vibrate longitudinally as a current flows through the voice coil 6. Therefore, in such case, the affixing element 7 is no longer needed.

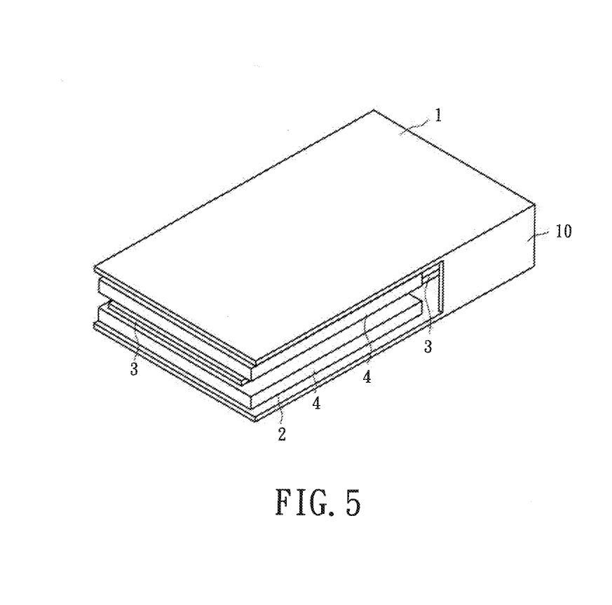

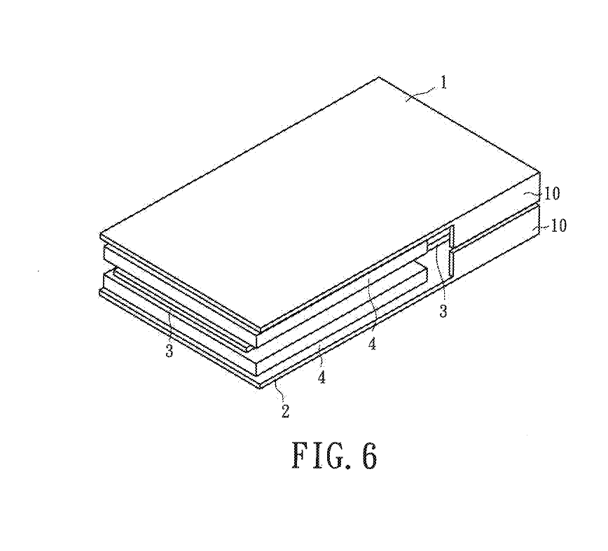

Now, please see FIGS. 5 and 6, which illustrate the third and fourth embodiments of the present invention. In FIG. 5 (the third embodiment), an extended magnetic part 10 integrally formed with the upper magnetic portion 1 and the lower magnetic portion 2 connects the upper magnetic portion 1 with the lower magnetic portion 2. In FIG. 6 (the fourth embodiment), there is a gap between an upper extended magnetic part 10 integrally formed with the upper magnetic portion 1 and a lower extended magnetic part 10 integrally formed with the lower magnetic portion 2. In either embodiment, as an AC current flow through the voice coil 6, the magnetic field of the extended magnetic part 10 can interact with the magnetic field generated by the voice coil 6.

Because speakers become thinner and thinner, the design of the present invention can make a speaker thinner than the prior art speaker and we only have to increase the length of magnets 4 to increase their volume to increase the magnetic force and hence offset the decrease in the magnetic force due to a thinner configuration.

From the above, we can see that the innovative magnetic design of the present invention meets the relevant patent requirements. It is hoped that the patent application will be approved.

Many changes and modifications in the above described embodiments of the invention can, of course, be carried out without departing from the scope thereof Accordingly, to promote the progress in science and the useful arts, the invention is disclosed and is intended to be limited only by the scope of the appended claims.

What is claimed is:

1. An innovative magnetic design for speakers, comprising:
an upper magnetic portion, which has the form of a plate;
a lower magnetic portion, which also has the form of a plate;
at least one magnetic piece, characterized in that a magnet is disposed between the upper magnetic portion and the magnetic piece and another magnet is disposed between the lower magnetic portion and the magnetic piece; and
two or more magnets, characterized in that either the lower surface of an upper magnet or the upper surface of a lower magnet should have the same magnetic polarity as the magnetic piece, the upper surface of the upper magnet should have the same magnetic polarity as the upper magnetic portion and the lower surface of the lower magnet should have the same magnetic polarity as the lower magnetic portion.

2. The innovative magnetic design as in claim 1, wherein, for example, if the lower surface of the upper magnet, the upper surface of the lower magnet and the magnetic piece are of south pole, then the upper surface of the upper magnet, the lower surface of the lower magnet, the upper magnetic portion and the lower magnetic portion should be of north pole.

3. The innovative magnetic design as in claim 1, wherein, conversely, if the lower surface of the upper magnet, the upper surface of the lower magnet and the magnetic piece are of north pole, then the upper surface of the upper magnet, the lower surface of the lower magnet, the upper magnetic portion and the lower magnetic portion should be of south pole.

4. The innovative magnetic design as in claim 1, wherein an extended magnetic part integrally formed with the upper magnetic portion and the lower magnetic portion connects the upper magnetic portion with the lower magnetic portion.

5. The innovative magnetic design as in claim 1, wherein there is a gap between an upper extended magnetic part integrally formed with the upper magnetic portion and a lower extended magnetic part integrally formed with the lower magnetic portion.
